(19) United States
(12) Patent Application Publication
(10) Pub. No.: US 2022/0390594 A1
(43) Pub. Date: Dec. 8, 2022

(54) VEHICLE IDENTIFICATION USING SURFACE-PENETRATING RADAR

(71) Applicants: Daniel JAMISON, Somerville, MA (US); Mohamed Shaib, Andover, MA (US); Connor Quinn, Austin, TX (US); Scott Hay, Amesbury, MA (US); Byron Stanley, Newton, MA (US)

(72) Inventors: Daniel JAMISON, Somerville, MA (US); Mohamed Shaib, Andover, MA (US); Connor Quinn, Austin, TX (US); Scott Hay, Amesbury, MA (US); Byron Stanley, Newton, MA (US)

(21) Appl. No.: 17/829,821

(22) Filed: Jun. 1, 2022

Related U.S. Application Data
(60) Provisional application No. 63/196,329, filed on Jun. 3, 2021.

(51) Int. Cl. G01S 13/89; G06N 3/08

(52) U.S. Cl. CPC G01S 13/89; G06N 3/08

(57) ABSTRACT

Surface-penetrating radar (SPR) is used to obtain images of a vehicle's undercarriage and employ these to identify the vehicle (or vehicle type or class). In particular, a vehicle may have a unique undercarriage SPR “signature” that remains largely stable over time, since it is not significantly affected by buildup of dirt, moisture or light debris. Even if the signature is not sufficiently differentiated from those of similar vehicles, it can be used to identify the vehicle within a class, which may be adequate for many purposes.

### CROSS-REFERENCE TO RELATED APPLICATION

This application claims priority to and the benefit of, and incorporates herein by reference in its entirety, U.S. Provisional Patent Application No. 63/196,329, filed on Jun. 3, 2021.

### FIELD OF THE INVENTION

The present invention relates, generally, to vehicle identification.

### BACKGROUND

Numerous technologies are currently used to remotely identify vehicles as they travel. So called “red light cameras” deployed at intersections capture a license-plate image when a vehicle runs a red light. Vehicle-borne toll-payment transponders may be used to identify vehicles and associate them with specific locations as vehicles pass under fixed tolling gantries. These systems interact only selectively with vehicles, i.e., for purposes of traffic enforcement and toll payment. They cannot be used, for example, to assist police in pursuit of a criminal driving a known vehicle, since data is generally not available in real time and in any case is collected only in locations relevant to traffic enforcement or toll transactions. Similarly, given their specific functions and consequent deployment locations, these systems are not easily used to collect broad statistical information about vehicle types and roadway usage.

### SUMMARY

Embodiments of the present invention use surface-penetrating radar (SPR) to obtain images of a vehicle's undercarriage and employ these to identify the vehicle (or vehicle type or class). In particular, a vehicle may have a unique undercarriage SPR “signature” that remains largely stable over time, since it is not significantly affected by buildup of dirt, moisture or light debris. Even if the signature is not sufficiently differentiated from those of similar vehicles, it can be used to identify the vehicle within a class, which may be adequate for many purposes. In various embodiments, SPR sensors are deployed within or adjacent a road bed. In the former case, as a vehicle passes over a sensor, an SPR image of the vehicle undercarriage is obtained and stored and/or transmitted, wirelessly or by wired means, to a central data-handling server. In roadway-adjacent embodiments, an SPR (or other radar) signal is directed at the roadway surface such that it will reflect from the surface and thereafter from the undercarriage of a passing vehicle. The reflection signal from the vehicle undercarriage is detected and processed into an SPR image.

Potential deployments for systems in accordance herewith are numerous. Most simply, the system may be installed anywhere vehicle information is desired, e.g., to determine the traffic composition along a stretch of roadway. Sensors may also be deployed at strategically chosen locations along selected traffic arteries to further surveillance or apprehension efforts. For example, if police receive reports of criminal activity associated with a particular vehicle or vehicle type, sensors may be activated (or data retrieved from them) along routes likely to be used by a fleeing perpetrator. Even identification of a generic vehicle type may be useful to police in deciding whether and where to mobilize available resources in pursuit.

Vehicles or vehicle types may be identified against entries in a database of stored SPR images. Identifying a specific vehicle requires a pedigree image for that vehicle to be in the database, while for class identification, one or more representative SPR images for the vehicle class may suffice. An acquired SPR image may be matched to a database entry using a registration process or a trained neural network, e.g., a convolutional neural network.

Accordingly, in a first aspect, the invention relates to a method of identifying an attribute of a vehicle. In various embodiments, the method comprises the steps of acquiring at least one SPR image of at least a portion of the vehicle's undercarriage; and computationally identifying the vehicle attribute based thereon.

In some embodiments, the acquired image is used as input to a predictor that has been computationally trained to identify vehicle attributes based on SPR images. For example, the predictor may be a neural network, e.g., a convolutional neural network. The acquired image may be compared to a database of SPR images associated with vehicle attributes and a best match identified, e.g., by registration, correlation or other suitable matching technique.

In a second aspect, the invention pertains to a system for detecting and identifying subsurface structures. In various embodiments, the system comprises an SPR system for acquiring at least one surface-penetrating radar (SPR) image of at least a portion of the vehicle's undercarriage; and a computer including a processor and electronically stored instructions, executable by the processor, for analyzing the at least one acquired SPR image and computationally identifying the vehicle attribute based thereon.

In various embodiments, the computer is configured to execute a predictor that has been computationally trained to identify vehicle attributes based on SPR images. The predictor may be a neural network, e.g., a convolutional neural network.

The computer may be configured to compare the acquired image to a database of SPR images associated with vehicle attributes and identify a best match, e.g, by registration, correlation or other suitable matching technique.

### BRIEF DESCRIPTION OF THE DRAWINGS

The foregoing and the following detailed description will be more readily understood when taken in conjunction with the drawings, in which:

FIG. 1 schematically illustrates an exemplary roadbed system for identifying vehicles using SPR in accordance with embodiments of the invention.

FIG. 2 schematically illustrates an exemplary roadside system for identifying vehicles using SPR in accordance with embodiments of the invention.

FIG. 3 schematically illustrates an exemplary architecture for a central server in accordance with embodiments of the invention.

### DETAILED DESCRIPTION

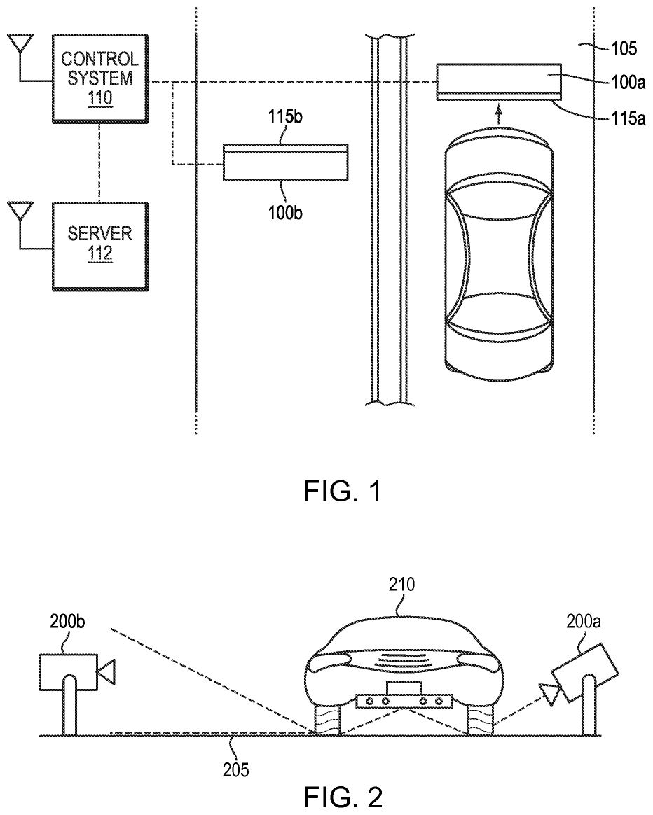

SPR systems have been used for navigation and vehicle localization; see, e.g., U.S. Pat. No. 8,949,024, the entire disclosure of which is incorporated by reference herein. The '024 patent describes a linear configuration of spatially-invariant transmit and receive antenna elements for transmitting radar signals. As shown in FIG. 1, linear antenna arrays 100a, 100b are deployed within a roadbed 105, e.g., substantially flush with its surface. The arrays 100a, 100b may be wired to a local control system 110, which supplies power to and communicates with the arrays 100a, 100b, receiving data (i.e., SPR images, status signals, etc.) during operation. The control system 110 may send SPR image data, wirelessly or via a wired connection, to a central data-handling server 112 for analysis as described below. Alternatively, the arrays 100a, 100b may have their own power sources (e.g., a combination of solar and battery power) and may be in wireless communication with the control system 110. The arrays 100a, 100b may be in accordance with the '024 patent or may have any suitable configuration. SPR arrays are well-known in the art.

In some embodiments, the arrays 100a, 100b are always active or are selectively activated by, e.g., the central server 112. For example, based on the location of a crime scene and, if available, a suspect's direction of flight, the central server 112 may algorithmically identify sensors to activate if information about the suspect's vehicle is known. In such circumstances, the central server 112 monitors incoming SPR data for a match, and as matches are detected, sensors more distant from the crime scene but consistent with the suspect's possible headings can be activated subsequently. Similarly, the server 112 can be programmed to periodically activate sets of sensors to ascertain the traffic composition along a particular thoroughfare in order to establish or adjust maintenance schedules.

In some embodiments, power is conserved by activating (or even allowing activation of) a sensor array only when a vehicle actually passes over it. As shown in FIG. 1, a conventional magnetic vehicle sensor 115a, 115b is installed just “upstream” (in terms of traffic direction) of the associated SPR sensor 100a, 100b. The SPR sensor is activated (or if operation is controlled by a remote server 112, allowed to become active, e.g., via the control system 110) when a vehicle approaches the magnetic sensor, and the SPR sensor is turned off once the magnetic sensor no longer detects a vehicle overhead.

In the linear configuration shown in FIG. 1, a sequence of SPR images is obtained as a vehicle passes over the sensor and these are concatenated by the control system 110, in a conventional fashion, into a single SPR image of the vehicle undercarriage. Alternatively, the sensor array may be elongated along the direction of vehicle travel and can acquire a single “snapshot” SPR image of the vehicle undercarriage when it is momentarily positioned above the sensor (as determined, e.g., by a magnetic sensor, a camera, etc.).

In another approach, the SPR signal can originate, and be received, adjacent to or above a roadway. As shown in FIG. 2, a pair of transceivers 200a, 200b are located on opposite sides of a roadway 205. When a vehicle 210 approaches, the transceiver 200a directs an SPR or other radar signal toward the roadbed, angled so that it will reflect and strike the undercarriage of the vehicle 210. In some embodiments, the sides and top of the vehicle may also be imaged. A metal plate may be embedded into or affixed on the roadway between the transceivers 200a, 200b to enhance reflection and thereby improve image quality. The return signal may be received by either or both transceivers 200a, 200b and used by the control system 110 to create an image of the vehicle undercarriage. As with the linear configuration described above, the vehicle image can be generated by concatenating the image returns as the vehicle drives past the transceiver pair. As a practical matter, it may be necessary or useful to employ a series of transceivers and concatenate across the transceivers and over time as the vehicle passes. A multiple-transceiver configuration can also take a “snapshot” image of the entire vehicle if the SPR array is elongated along the direction of the vehicle.

The scan data comparison to stored database SPR images may be a registration process based on, for example, correlation; see, e.g., U.S. Pat. No. 8,786,485, the entire disclosure of which is incorporated by reference herein. Alternatively, a machine-learning approach may be employed. The term “deep learning” refers to machine-learning algorithms that use multiple layers to progressively extract higher-level features from raw images. Deep learning generally involves neural networks, which process information in a manner similar to the human brain. The network is composed of a large number of highly interconnected processing elements (neurons) working in parallel to solve a specific problem. Neural networks learn by example; they must be properly trained with carefully collected and curated training examples to ensure high levels of performance, reduce training time, and minimize system bias.

Convolutional neural networks (CNNs) are often used to classify images or identify (and classify) objects pictured in an image scene. A self-driving vehicle application, for example, may employ a CNN in a computer-vision module to identify traffic signs, cyclists or pedestrians in the vehicle's path. The CNN extracts features from an input image using convolution, which preserves the spatial relationship among pixels but facilitates learning the image features using small squares of input data. Neural networks learn by example, so images may be labeled as containing or not containing a feature of interest. The examples are selected carefully, and usually must be large in number, if the system is to perform reliably and efficiently.

Accordingly, a CNN may be trained on many SPR images of vehicle undercarriages corresponding to different vehicle types. The CNN can then classify a new SPR image in accordance with the classes it has been trained to recognize. Although this approach generally cannot uniquely identify an SPR image as corresponding to a specific vehicle, it may be faster and more robust than a registration approach. The CNN may output both the best classification and an associated probability.

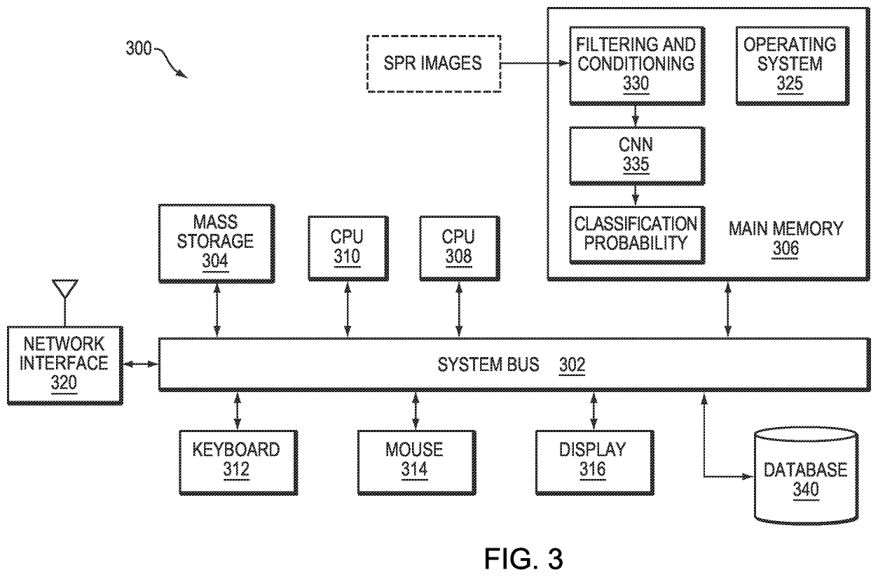

A deep learning classifier for vehicle recognition may be implemented in the central server 112 (or, if desired, in the control system 110). An exemplary architecture for the server 112 is shown in FIG. 3. As illustrated, the system 300 includes a main bidirectional bus 302, over which all system components communicate. The main sequence of instructions effectuating the functions of the invention and facilitating interaction between the server 300 and the various control systems 110 reside on a mass storage device (such as a hard disk, solid-state drive or optical storage unit) 304 as well as in a main system memory 306 during operation. Execution of these instructions and effectuation of the functions of the invention are accomplished by a central processing unit (“CPU”) 308 and, optionally, a graphics processing unit (“GPU”) 310. The user may interact with the system 300 using a keyboard 312 and a position-sensing device (e.g., a mouse) 314. The output of either device can be used to designate information or select particular areas of a screen display 316 to direct functions to be performed by the system. A network interface 320, which is typically wireless and communicates using a suitable protocol (e.g., TCP/IP) over the public cellular telecommunications infrastructure, allows the server 300 to communicate with the various controllers 110.

The main memory 306 contains instructions, conceptually illustrated as a group of modules, that control the operation of the CPU 308 and its interaction with the other hardware components. An operating system 325 directs the execution of low-level, basic system functions such as memory allocation, file management and operation of mass storage devices 304. Typical operating systems include MICROSOFT WINDOWS, LINUX, iOS, and ANDROID.

A filtering and conditioning module 330 appropriate to a deep learning submodule, such as a CNN 335, may also be implemented as a software subsystem. For example, SPR images may be preprocessed by the module 325 to resize them to the input size of the CNN 300. The filtering and conditioning module 325 may also perform conventional denoising, edge smoothing, sharpening, and similar operations on the incoming SPR images. In one embodiment, the CNN 330 analyzes incoming SPR images from one or more of the controllers 110 and computes a classification probability among vehicle types.

The CNN 335 may be implemented without undue experimentation using commonly available libraries. Caffe, CUDA, PyTorch, Theano, Keras and TensorFlow are suitable neural network platforms (and may be cloud-based or local to an implemented system in accordance with design preferences). The input to the CNN 335 is typically an image but may be a vector of input values (a “feature” vector), e.g., the two-dimensional readings of an SPR scan and system health information. Suitable neural network architectures are well-known in the art and include VGG16, various ResNet models (e.g., ResNet50, ResNet101), AlexNet, MobileNet, EfficientNet, etc.

Alternatively, or in addition, a database 340 containing identifying information for specific vehicles or vehicle types may be used to identify a vehicle with greater specificity. For example, the CNN 335 may efficiently classify the vehicle, enabling identification of a subset of vehicle entries in the database 340 that may be queried based on additional information from the SPR scan. This additional information may be part of a vehicle's pedigree (in the manner of a VIN) or may reflect an anomaly (e.g., a loose muffler) known to be associated with a particular vehicle or vehicle type. The point is that the CNN 335 may represent a first simplifying stage of classification or, in some embodiments, may be omitted and the SPR scan used directly (or after some initial processing) to locate a vehicle record in the database 340. For example, the acquired image may simply be compared to SPR images in the database 340 and a best match identified, e.g., by registration or correlation.

Both the control systems 110 and the server 112 may include one or more modules implemented in hardware, software, or a combination of both. For embodiments in which the functions are provided as one or more software programs, the programs may be written in any of a number of high-level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80×86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of identifying an attribute of a vehicle, the method comprising the steps of:
acquiring at least one surface-penetrating radar (SPR) image of at least a portion of the vehicle's undercarriage; and
computationally identifying the vehicle attribute based thereon.

2. The method of claim 1, wherein the acquired image is used as input to a predictor that has been computationally trained to identify vehicle attributes based on SPR images.

3. The method of claim 1, wherein the predictor is a neural network.

4. The method of claim 1, wherein the neural network is a convolutional neural network.

5. The method of claim 1, wherein the acquired image is compared to a database of SPR images associated with vehicle attributes and a best match identified.

6. The method of claim 5, wherein the best match is identified by registration.

7. A system for detecting and identifying subsurface structures, the system comprising:
a surface-penetrating radar (SPR) system for acquiring at least one SPR image of at least a portion of the vehicle's undercarriage; and
a computer including a processor and electronically stored instructions, executable by the processor, for analyzing the at least one acquired SPR image and computationally identifying the vehicle attribute based thereon.

8. The system of claim 7, wherein the computer is configured to execute a predictor that has been computationally trained to identify vehicle attributes based on SPR images.

9. The system of claim 8, wherein the predictor is a neural network.

10. The system of claim 8, wherein the neural network is a convolutional neural network.

11. The system of claim 7, wherein the computer is configured to compare the acquired image to a database of SPR images associated with vehicle attributes and identify a best match.

12. The system of claim 11, wherein the best match is identified by registration.
